(19) United States
(12) Patent Application Publication
(10) Pub. No.: US 2012/0139304 A1
(43) Pub. Date: Jun. 7, 2012

(54) VEHICLE SEAT WITH OXYGEN TANK STORAGE

(76) Inventor: Jae Ho JANG, Daejeon (KR)

(21) Appl. No.: 13/169,565

(22) Filed: Jun. 27, 2011

(30) Foreign Application Priority Data
Dec. 3, 2010 (KR) 10-2010-0122473

(51) Int. Cl. B60N 2/44

(52) U.S. Cl. 297/188.04

(57) ABSTRACT

Disclosed is a vehicle seat for use in a fire truck or an ambulance. The vehicle seat includes a seat back frame defining an oxygen tank receiving space therein to receive an oxygen tank, a seating bracket attached to a lower position of the seat back frame so as to support a lower end of the oxygen tank seated thereon, a holder pivotally attached to an upper position of the seat back frame and integrally connected to a headrest so as to catch and support an upper end of the oxygen tank, an elastic fixing unit to assist the holder in continuously supporting the upper end of the oxygen tank, and a release cable to release the elastic fixing unit when it is pulled, causing the holder supporting the oxygen tank to be lifted by restoration force of the spring, thereby enabling separation of the oxygen tank.

### BACKGROUND

1. Technical Field

The present invention relates to a vehicle seat for use in a fire truck, an ambulance or the like, and more particularly, to a vehicle seat wherein a seat back frame includes an oxygen tank receiving space defined therein to receive an oxygen tank, which is used by a fire fighter or a rescue man in a fire or accident, while providing a sitter with a comfortable posture without influence by the oxygen tank, wherein a seating bracket is attached to a lower position of the seat back frame such that a lower end of the oxygen tank is seated on the seating bracket, wherein a holder, by which an upper end of the oxygen tank is caught, is pivotally attached to an upper position of the seat back frame and is integrally connected to a headrest, wherein an elastic fixing unit using a spring serves to assist the holder in continuously supporting the upper end of the oxygen tank, and wherein the elastic fixing unit is released when a release cable is pulled, causing the holder supporting the oxygen tank to be lifted by restoration force of the spring, thereby enabling separation of the oxygen tank.

2. Description of Related Art

Conventional technology relating to a fire truck seat in which an oxygen tank is installed to the back of the seat, which falls within the technical field associated with the present invention, are disclosed in Korean Utility Model Registration No. 321505, U.S. Pat. No. 6,702,242, U.S. Pat. No. 5,275,462, U.S. Pat. No. 5,213,392, U.S. Pat. No. 5,354,029 etc., in addition to Korean Utility Model Registrations No. 312633, No. 334661 and No. 410615, which are filed by the applicant of the present invention.

In the aforementioned disclosures, conventionally, a space is defined in or at the inner side of a seat back of a fire truck or ambulance such that an oxygen tank is received in the space and is separably fixed using a band or a clamp. Since the seat back is a region where a passenger of the fire truck or ambulance rests his/her back, installing the oxygen tank to the seat back may cause the passenger discomfort. Further, providing the seat back used to support the backbone of the passenger with a recessed configuration may cause the seat back to fail to comfortably support the back of the passenger. For these reasons, the above described conventional seat results in deterioration in ease and comfort of the passenger who is exhausted after putting out a fire or saving a life.

Other problems of the above described conventional seats are that the oxygen tank is visually exposed from the seat back, causing the inside of a vehicle in a mess and providing no sense of security, and that they do not provide particular receptacles for other small tools, such as helmets or gloves, thus suffering from troublesome storage and use of these small tools.

To solve the above described problems, the applicant of the present invention suggested a vehicle seat in which an oxygen tank is installed to a seat back as disclosed in Korean Patent Laid Open Publication No. 10-2010-0005748. Referring to FIG. 7, the vehicle seat includes a seat cushion 1 to support the hips of a sitter and a seat back 10 to which an oxygen tank B is installed. The seat back 10 includes a front surface 12 having a cushion to support the back of the sitter and a rear surface 14 to which an oxygen tank fixing device 20 is attached. The seat back 10 is centrally provided with a rotating shaft 16 such that the front surface 12 and the rear surface 14 are inverted via horizontal rotation of the seat back 10 about the rotating shaft 16. The seat back 10 is further provided at one side thereof with a locking unit 30 to keep the front surface 12 and the rear surface 14 inverted. In addition, a small tool receptacle 40 is provided at the top of the seat back 10.

However, the above described vehicle seat as disclosed in Patent Laid Open Publication No. 10-2010-0005748 has a disadvantage in that the vehicle seat may be applied only to vehicles in which a sufficient space for the horizontal rotation of the seat back is present at the rear side of the seat back.

### SUMMARY

Therefore, the present invention has been made in view of the above problems, and it is an object of the present invention to provide a vehicle seat having an improved configuration to install an oxygen tank to a seat back, which can be applied to a vehicle having no extra space at the rear side of the seat back, which can provide a sitter, such as a fire fighter or a rescue man, with a comfortable posture without any inconvenience due to the presence of the oxygen tank, and which can ensure easy and rapid installation and separation of the oxygen tank.

In accordance with an aspect of the present invention, the above and other objects can be accomplished by the provision of a vehicle seat including a pair of seat backs between which an oxygen tank is accommodated, a seat back frame, which constitutes a part of a seat back structure and includes an oxygen tank receiving space defined therein, a seating bracket attached to a lower position of the seat back frame so as to support a lower end of the oxygen tank seated thereon, a holder pivotally attached to an upper position of the seat back frame and serving to catch an upper end of the oxygen tank, the holder being integrally connected to a headrest, an elastic fixing unit using a spring to assist the holder in continuously catching and supporting the upper end of the oxygen tank, and a release cable to release the elastic fixing unit when it is pulled, so as to allow the holder supporting the oxygen tank to be lifted by restoration force of the spring, enabling separation of the oxygen tank.

The headrest may be provided with a mask receptacle to store an oxygen mask.

The seat backs may be arranged at left and right sides of the oxygen tank receiving space and an auxiliary back support may be detachably attached to the seat backs so as to extend across the seat backs in a state in which the oxygen tank is received in the oxygen tank receiving space.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a vehicle seat in accordance with the present invention;

FIG. 2 is a front view of the vehicle seat in accordance with the present invention;

FIG. 3 is a side sectional view of the vehicle seat in accordance with the present invention;

FIG. 4 is a perspective view illustrating a state in which an auxiliary back support is attached to a seat back in a state in which an oxygen tank is installed to the seat back;

FIG. 5 is a front view illustrating an operation mode of a headrest and a holder;

FIG. 6 is a side view illustrating the sequence of an oxygen tank mounting operation; and

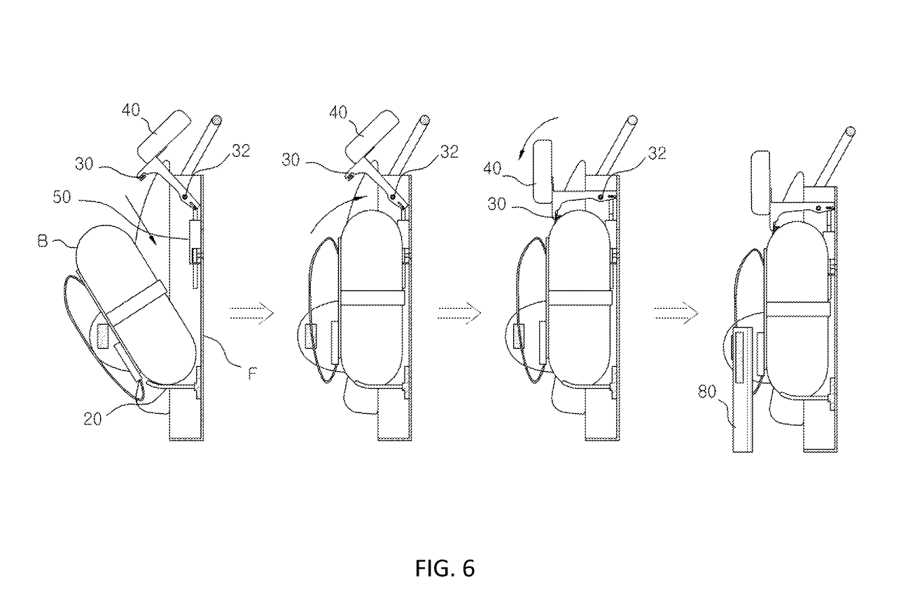

FIG. 7 is a perspective view illustrating a conventional vehicle seat disclosed by the applicant of the present invention.

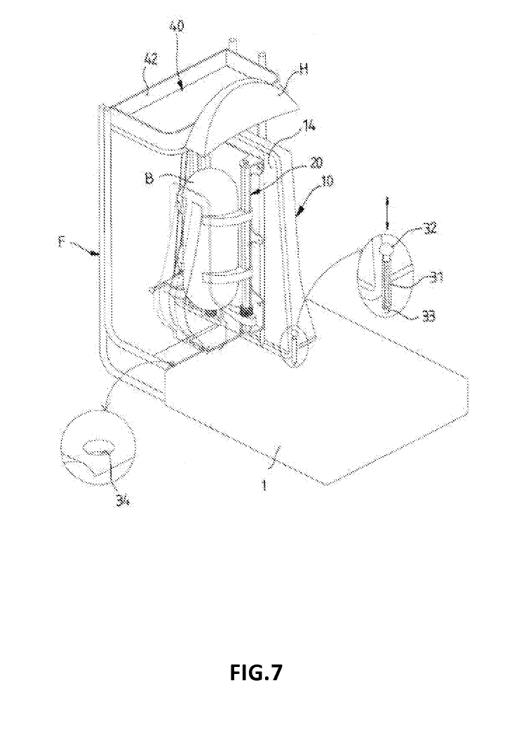

### DETAILED DESCRIPTION OF PREFERRED EMBODIMENTS

Hereinafter, preferred embodiments of the present invention will be described in detail with reference to the accompanying drawings, although the present invention is not limited thereto.

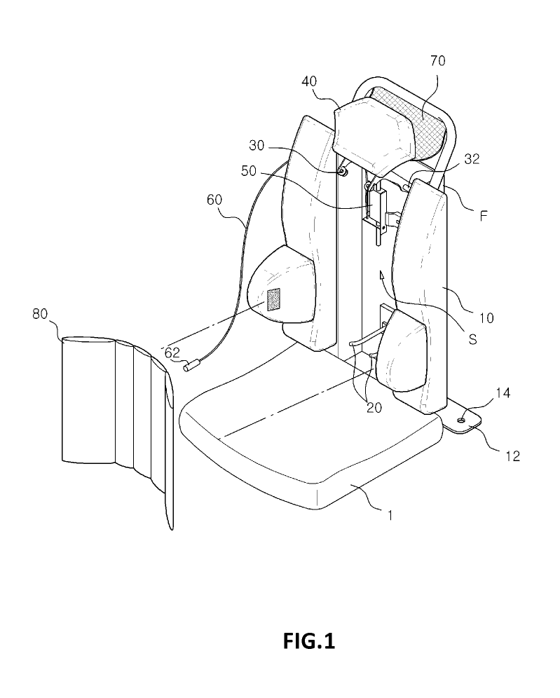

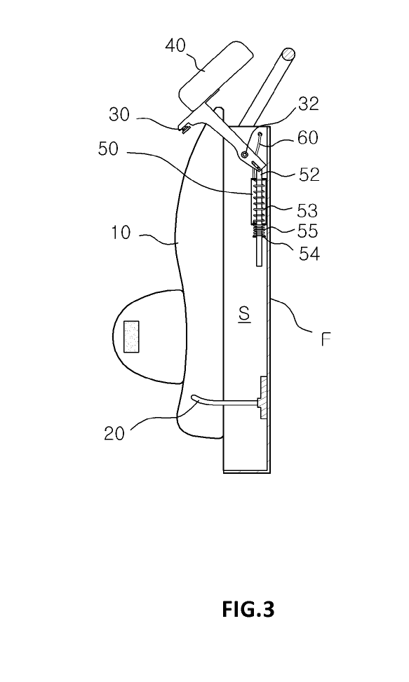

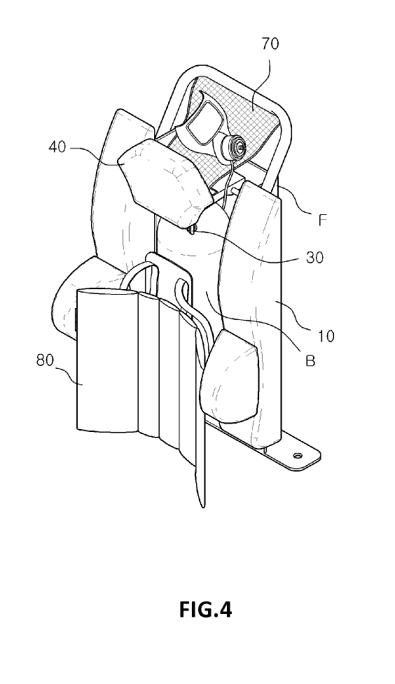

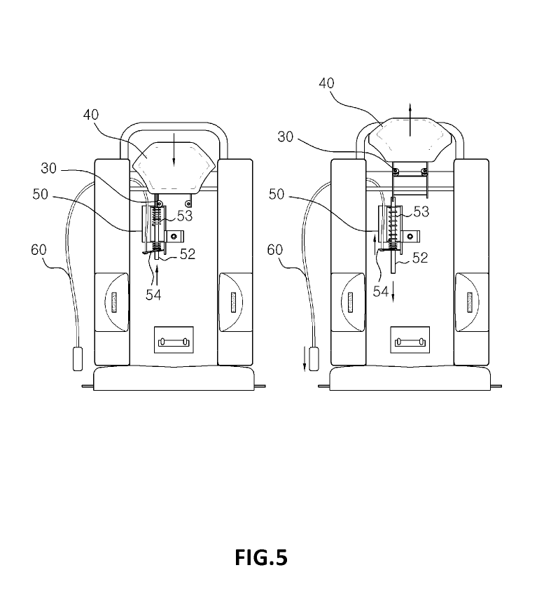

FIGS. 1 to 5 illustrate a vehicle seat in accordance with the present invention. As illustrated in FIGS. 1 to 5, the vehicle seat in accordance with the present invention includes a seat cushion 1 to support the hips of a sitter and a pair of seat backs 10 between which an oxygen tank B is accommodated. A seat back frame F, which constitutes a part of a seat back structure, includes an oxygen tank receiving space S defined therein. A seating bracket 20 is attached to a lower position of the seat back frame F so as to support a lower end of the oxygen tank B seated thereon. A holder 30 is pivotally attached to an upper position of the seat back frame F and serves to catch an upper end of the oxygen tank B. The holder 30 is integrally connected to a headrest 40. An elastic fixing unit 50 using a spring serves to assist the holder 30 in continuously catching and supporting the upper end of the oxygen tank B. As the elastic fixing unit 50 is released when a release cable 60 is pulled, the holder 30 supporting the oxygen tank B is lifted by restoration force of the spring, enabling separation of the oxygen tank B.

The seat back frame F constituting the seat back structure is formed by pressing a metal plate in such a manner that the oxygen tank receiving space S is defined in the seat back frame F. The pair of seat backs 10 is attached to left and right sides of the seat back frame F so as to define the oxygen tank receiving space S therebetween. A bottom portion 12 of the seat back frame F is perforated with bolt holes 14 such that the seat back frame F is fastened to the bottom of a vehicle such as a fire truck or the like.

In the seat back frame F in accordance with the present invention, a single seat back frame F may be provided in the case of a front seat (i.e. the seat next to the driver), and two or three seat back frames F may be horizontally arranged adjacent to each other in the case of a second row or third row rear seat. In this case, a small size single seat cushion 1 may be provided in the case of the front seat as illustrated in the drawings, but a horizontally elongated seat cushion for two or three persons may be provided in the case of the second row or third row rear seat, although this is not illustrated in the drawings.

In the present invention, the seat backs 10, which are attached to left and right positions of a front surface of the seat back frame F, serve to support left and right parts of the back of the sitter, and an auxiliary back support 80 may be detachably attached to the seat backs 10 by means of Velcro straps, which enables more comfortable support of the back of the sitter.

The seating bracket 20 is attached to the lower position of the seat back frame F including the oxygen tank receiving space S defined therein such that the lower end of the oxygen tank B is seated on the seating bracket 20. The seating bracket 20 has a U-shaped form and protrudes forward by a length sufficient to allow left and right edges of the lower end of the oxygen tank B to be seated thereon. Distal ends of the U-shaped seating bracket 20 are bent upward to prevent the oxygen tank B from being unintentionally moved forward during travel. A surface of the seating bracket 20 is coated with rubber, soft silicon or the like, which prevents frictional noise.

The holder 30, which is integrally formed with the headrest 40, is pivotally installed at an approximately center portion thereof to the upper position of the seat back frame F by means of a pivoting shaft 32. The holder 30 comes into close contact with a front position of a semi-spherical upper portion of the oxygen tank B, thereby functioning to prevent unintentional separation of the oxygen tank B seated on the seating bracket 20. A pad, which is made of synthetic resin or rubber, is attached to an area of the holder 30 which comes into contact with the oxygen tank B, which prevents frictional noise or collision noise.

The elastic fixing unit 50 is connected to a rear end of the holder 30 and serves to keep the holder 30 at a fixed position while allowing pivoting of the holder 30 about the pivoting shaft 32.

The headrest 40 is attached to a tip end of the holder 30 so as to support the head of the sitter. By manually pushing the headrest 40 down or up, the headrest 40 and the holder 30 are adjustable in angle.

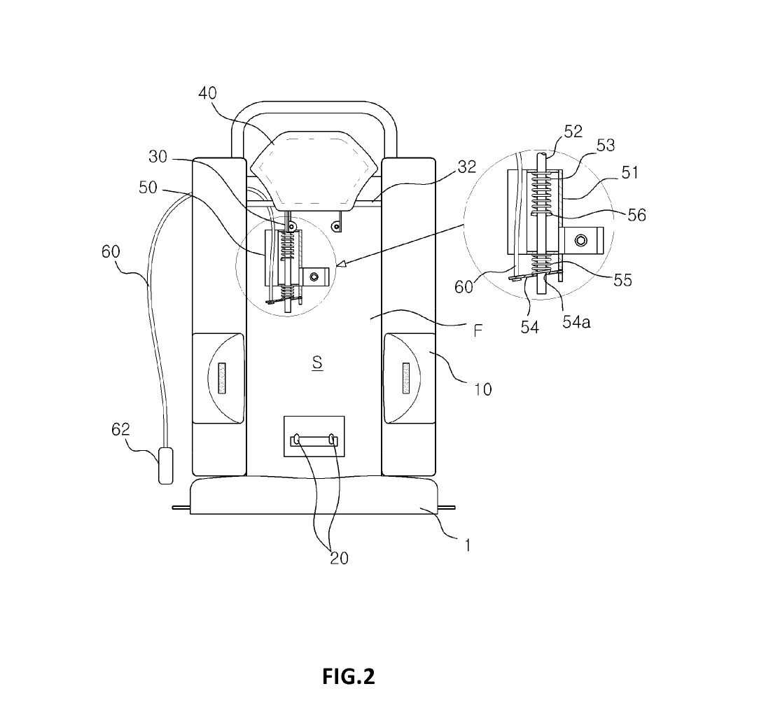

The elastic fixing unit 50, as illustrated in FIG. 2, includes a housing 51 secured to the seat back frame F, a rod 52 installed in the housing 51 so as to vertically slide, a spring 53 to push the rod 52 downward, a stopper 54 to restrict a sliding operation of the rod 52, and a loading spring 55 to allow the stopper 54 to be continuously caught by the rod 52. An upper end of the rod 52 is pin-coupled to a rear end of the holder 30 which is pivotable about the pivoting shaft 32. The stopper 54 is connected to the release cable 60.

In the drawings, reference numeral 56 represents a spring retainer protruding outward from the rod 52. The spring retainer 56 supports a lower end of the spring 53 in the form of a compressive coil spring such that the spring 53 applies pressure to the rod 52 downward.

The stopper 54 is pivotally secured at a rear end thereof to the housing 51 and centrally has a through-hole 54a through which the rod 52 penetrates. The through-hole 54a does not interfere with vertical sliding of the rod 52 in a state in which the stopper 54 is horizontally oriented. However, since the stopper 54 is tilted by the loading spring 55 in the form of a compressive coil spring, a vertical cross section of the through-hole 54a is smaller than a cross section of the rod 52, which causes an outer peripheral surface of the rod 51 to frictionally come into close contact with the through-hole 54a. Thereby, even if the rod 52 is forced downward by the spring 53, the rod 52 remains stationary. Then, if the release cable 60 connected to a front end of the stopper 54 is pulled, the stopper 54, which has tilted by the loading spring 55, is changed into a horizontal orientation, having an increased vertical cross section of the through-hole 54a. Thereby, the stopper 54 is released from the rod 52, allowing the rod 52 to be pushed downward by pressure of the spring 53.

Once the rod 52 is pushed downward by the spring 53, the headrest 40 and the holder 30, which are pivotally fixed about the pivoting shaft 32, are rotated counterclockwise. Thereby, the holder 30 is released from the upper end of the oxygen tank B, enabling separation of the oxygen tank B.

The release cable 60 extends by an appropriate length and is located at one side of the seat cushion 1. With this configuration, the sitter can operate the elastic fixing unit 50 in a sitting posture by simply pulling a knob 62 provided at a tip end of the release cable 60.

In the present invention, additionally, a mask receptacle 70 is provided at the rear side of the headrest 40 to receive an oxygen mask. The mask receptacle 70 is formed of a flexible material, such as a net, and has no effect on pivoting operation of the headrest 40.

With the above described configuration in accordance with the present invention, owing to the auxiliary back support 80 attached to the seat backs 10 in a state in which the oxygen tank B is received between the seat backs 10, it is possible to provide a sitter, such as a fire fighter or a rescue man, with a comfortable posture. Since the oxygen tank B is firmly secured by means of the seating bracket 20 and the holder 30 attached to the seat back frame F, the oxygen tank B has no effect on the sitter, such as a fire fighter or a rescue man, which ensures more free activity of the fire fighter or the rescue man. In addition, the oxygen tank B can be rapidly released if the sitter pulls the knob 62 provided at the tip end of the release cable 60 in a sitting posture as soon as the sitter reaches a fire or accident. Thus, the sitter can easily pick the oxygen tank B out of the oxygen tank receiving space S by detaching the auxiliary back support 80 from the seat backs 10, in order to use the oxygen tank B in fire fighting or lifesaving.

After completion of fire fighting or lifesaving, the sitter can easily secure the oxygen tank B to an original position thereof and attain a comfortable seat.

As is apparent from the above description, the present invention provides a vehicle seat in which an oxygen tank is received in an oxygen tank receiving space defined between a pair of seat backs while being firmly caught by a holder. When it is desired to separate and use the oxygen tank, as a sitter pulls a release cable such that a holder, which has remained stationary by an elastic fixing unit, is pivoted along with a headrest, the oxygen tank can be released from the holder and be separated from the oxygen tank receiving space. After use of the oxygen tank, the oxygen tank can again be rapidly mounted into the oxygen tank receiving space between the seat backs by placing a lower end of the oxygen tank on a seating bracket attached to the seat back frame and manually pushing the headrest down. In this way, it is possible to eliminate any inconvenience with relation to carrying and storage of the oxygen tank. Furthermore, with the presence of an auxiliary back support, it is possible to stably support the back of the sitter without causing the sitter discomfort due to the oxygen tank. In addition, it is possible to properly arrange other small tools, such as an oxygen mask, as well as the oxygen tank, which provides the passenger with a sense of security.

Although illustrative embodiments of the present invention have been described herein with reference to the accompanying drawings, it is to be understood that the present invention is not limited to those precise embodiments, and those skilled in the art will appreciate that various modifications, additions and substitutions are possible, without departing from the scope and spirit of the invention as disclosed in the accompanying claims.

What is claimed is:

1. A vehicle seat comprising a seat cushion to support the hips of a sitter and a pair of seat backs between which an oxygen tank is accommodated, the vehicle seat comprising:
a seat back frame, which constitutes a part of a seat back structure and includes an oxygen tank receiving space defined therein;
a seating bracket attached to a lower position of the seat back frame so as to support a lower end of the oxygen tank seated thereon;
a holder pivotally attached to an upper position of the seat back frame and serving to catch an upper end of the oxygen tank, the holder being integrally connected to a headrest;
an elastic fixing unit using a spring to assist the holder in continuously catching and supporting the upper end of the oxygen tank; and
a release cable to release the elastic fixing unit when it is pulled, so as to allow the holder supporting the oxygen tank to be lifted by restoration force of the spring, enabling separation of the oxygen tank.

2. The vehicle seat according to claim 1, wherein:
the seat back frame is formed by pressing a metal plate in such a manner that the oxygen tank receiving space is defined in the seat back frame;
the pair of seat backs is attached to left and right sides of the seat back frame so as to define the oxygen tank receiving space therebetween; and
a bottom portion of the seat back frame is perforated with bolt holes such that the seat back frame is fastened to the bottom of a vehicle.

3. The vehicle seat according to claim 2, wherein an auxiliary back support is detachably attached to the seat backs, provided at left and right positions of a front surface of the seat back frame, by means of Velcro straps.

4. The vehicle seat according to claim 1, wherein:
the elastic fixing unit includes:
a housing secured to the seat back frame;
a rod installed in the housing so as to vertically slide;
a spring to push the rod downward;
a stopper to restrict a sliding operation of the rod; and
a loading spring to allow the stopper to be continuously caught by the rod;
an upper end of the rod is pin-coupled to a rear end of the holder which is pivotable about a pivoting shaft; and
the stopper is connected to the release cable.

5. The vehicle seat according to claim 4, wherein:
the stopper is pivotally secured at a rear end thereof to the housing and centrally has a through-hole through which the rod penetrates;
the through-hole does not interfere with vertical sliding of the rod in a state in which the stopper is horizontally oriented;
a vertical cross section of the through-hole is smaller than a cross section of the rod in a state in which the stopper is tilted by the loading spring in the form of a compressive coil spring, which causes an outer peripheral surface of the rod to frictionally come into close contact with the through-hole and the rod to remain stationary even if the rod is forced downward by the spring;
the stopper, which has tilted by the loading spring, is changed into a horizontal orientation if the release cable connected to a front end of the stopper is pulled, thus having an increased vertical cross section of the through-hole and allowing the stopper to be released from the rod.

6. The vehicle seat according to claim 1, wherein a mask receptacle is provided at the rear side of the headrest to receive an oxygen mask, and is formed of a flexible net material.
